(19) United States
(12) Patent Application Publication
(10) Pub. No.: US 2026/0138477 A1
(43) Pub. Date: May 21, 2026

(54) INDUCTIVE CHARGING DEVICE FOR A VEHICLE CHARGING SYSTEM

(71) Applicant: MAHLE International GmbH, Stuttgart (DE)

(72) Inventor: Mike Boettigheimer, Kornwestheim (DE)

(21) Appl. No.: 19/104,201

(22) PCT Filed: Jun. 6, 2023
(86) PCT No.: PCT/EP2023/065151

§ 371 Date: Dec. 9, 2025

(30) Foreign Application Priority Data
Aug. 16, 2022 (DE) 10 2022 120 695.5
Sep. 28, 2022 (DE) 10 2022 125 036.9

(51) Int. Cl. B60L 53/39; B60L 53/126; B60L 53/36; B60L 53/66

(52) U.S. Cl. CPC B60L 53/39; B60L 53/126; B60L 53/36; B60L 53/66

(57) ABSTRACT

An inductive charging device for a vehicle charging system having an energy transmission winding and at least one flux guiding element is disclosed. A near positioning transmitter is suitable for generating at least one near positioning signal, and a remote positioning transmitter is suitable for generating at least one remote positioning signal. A method for positioning a vehicle is also disclosed.

### CROSS-REFERENCE TO RELATED APPLICATIONS

This application claims priority to International Patent Application No. PCT/EP2023/065151 filed on Jun. 6, 2023, which also claims priority to German Patent Application DE 10 2022 125 036.9 filed Sep. 28, 2022 and German Patent Application DE 10 2022 120 695.5 filed Aug. 16, 2022, the contents of each of which is hereby incorporated by reference in its entirety.

### TECHNICAL FIELD

The invention relates to an inductive charging device for a vehicle charging system, a vehicle charging system, and a method for positioning a vehicle having a mobile inductive charging device in a defined position relative to a stationary inductive charging device according to the class of independent claims.

### BACKGROUND

DE 10 2014 202 747 A1 discloses a double winding system which is used to determine a positional deviation between a primary coil and a secondary coil of an inductive charging system. The two windings of the double winding system are offset with respect to each other by a certain angle and wound around a common ferrite element. The magnetic field of the primary coil induces a voltage in the two windings. The two voltages are evaluated by an evaluation unit and a position deviation between the primary coil and the secondary coil is calculated. The double winding system shown is used as a sensor for only one process that detects a position deviation. Such a method can become imprecise or no longer function adequately with a minimum bar level.

### SUMMARY

The present invention deals with the task of providing improved or at least alternative embodiments for an inductive charging device of the type mentioned at the beginning, in particular those which enable a positioning method over the widest possible range of distances.

The ability to charge vehicles inductively offers a plurality of advantages over conventional conductive charging. First and foremost, there is the added convenience of not having to handle sometimes very heavy charging cables and plugs. However, it is important for the inductive charging process that the vehicle's inductive charging device is positioned as closely as possible to the stationary inductive charging device, for example on the ground. This is difficult due to the purely manual positioning of the vehicle over the stationary inductive charging device and the driver requires support from an assistance system, which either provides them with information about a positional deviation between the mobile inductive charging device in the vehicle and the stationary inductive charging device or from an automated positioning system, which takes over the parking process automatically. A sensor system is required that can detect a corresponding deviation in position. It is advantageous if no initial calibration is required between the stationary inductive charging device and the mobile inductive charging device in the vehicle. The longest possible range is also advantageous for the positioning system. This means that the positioning system should be able to precisely determine a positional deviation at the greatest possible distance between a stationary inductive charging device and a mobile inductive charging device in the vehicle and also function up to a sufficiently precise positioning.

An inductive charging device for a vehicle charging system is proposed here having an energy transmission winding and at least one flux guiding element and with a near positioning transmitter which is suitable for generating at least one near positioning signal, and a remote positioning transmitter which is suitable for generating at least one remote positioning signal.

With inductive charging, energy is transferred in the form of a magnetic field between two inductive charging devices, usually between a stationary charging device and a mobile inductive charging device.

The term “inductive charging device” therefore only refers to one of at least two parts that are required for an induction charging process to transfer energy. During the induction charging process, an energy transmission winding in an inductive charging device generates an alternating magnetic field. This alternating magnetic field induces a voltage in another energy transmission winding of another inductive charging device. This further inductive charging device thus serves as a counterpart for this specific charging process. The energy is transmitted wirelessly and absorbed by induction of a voltage.

Inductive charging devices can be used for the inductive charging of vehicles. In principle, an inductive charging device according to the invention can be used for any type of land, water, or air vehicle that has an electric or hybrid drive. Passenger cars, buses, and trucks are particularly mentioned.

A vehicle charging system comprises at least one mobile inductive charging device and a further, usually stationary inductive charging device. A mobile inductive charging device can, for example, be mounted on and/or in a vehicle.

An inductive charging device on and/or in the vehicle is therefore suitable for picking up the magnetic field and providing electrical energy from an energy storage device in the vehicle, for example a battery or an accumulator in the vehicle.

In principle, a vehicle charging system can also be used for bidirectional charging. In this case, the vehicle can also temporarily feed energy from the energy storage device into the power grid via the vehicle charging system.

Further important features and advantages of the invention are apparent from the dependent claims, from the drawings, and from the associated description of the figures with reference to the drawings.

An inductive charging device has an energy transmission winding that can efficiently receive a magnetic field from another energy transmission winding during the charging process and/or can emit a magnetic field. Preferably, power from 3 kW to 500 kW can be transmitted, particularly preferably from 3 kW to 50 kW.

In general, a coil is defined here as a component for generating or receiving a magnetic field. A coil can consist of a winding and optional other elements such as a magnetic core and a coil carrier. A winding here is a wound arrangement of a current conductor. A winding can consist of one or more turns, wherein a turn denotes a full turn of a conductor. In general, however, a winding can also consist of less than one turn, for example 0.5 turns. Of course, a non-complete number of windings, such as 2.5 windings, is also possible.

An energy transmission winding can be designed in various forms and can, for example, consist of a high frequency Litz wire with a diameter of between 0.5 mm and 10 mm, preferably made of copper.

A flux guiding element is suitable for guiding a magnetic field in a predetermined manner. It has a high magnetic permeability of μᵣ>1, preferably μᵣ>50, particularly preferably μᵣ>100. The flux guiding element is a magnetic core for the energy transmission winding. In particular, the magnetic field is influenced by the high permeability in such a way that the greatest possible magnetic flux is transferred to the energy transmission winding. With a flux guiding element, the energy transmission winding picks up a greater magnetic flux than without a flux guiding element, all other parameters being equal. A flux guiding element can be made of a ferromagnetic or preferably of a ferrimagnetic material, particularly preferably of a ferrite. A flux guiding element can preferably be plate-like—in the form of a planar core—and be arranged in the inductive charging device on the side of the energy transmission winding that faces away from the opposite side, i.e., the other inductive charging device.

A positioning transmitter is a device that enables at least one positioning signal to be transmitted. A positioning transmitter can consist of several elements, which can also be spatially separated from each other. It is also possible for a positioning transmitter to emit several positioning signals. A positioning transmitter is used to generate the positioning signals for a positioning method.

For an optimal positioning process, it is important that the longest possible range is achieved, i.e., that positioning is possible at the greatest possible distance between the two inductive charging devices. On the other hand, it is important that positioning is still possible even at small distances between the two inductive charging devices until sufficiently precise positioning is achieved.

The distances here always refer to a distance to an optimum positioning. In the case of stationary inductive charging devices arranged on or in the substrate, optimum positioning may be present if the two centers of the inductive charging devices are vertically above each other in the plane parallel to the substrate. In this case, the distances are always determined in relation to these centers. The distance between the two inductive charging devices therefore refers here to the distance between the two centers of the two inductive charging devices in relation to the plane parallel to the substrate. Different positioning methods may be optimal for different regions of distances between the two inductive charging devices. For example, a positioning method that achieves the greatest possible range, i.e., the greatest possible distance between the two inductive charging devices, may be inadequate for small distances. A positioning method that delivers precise values at short distances may have too short a range. It is therefore advantageous to combine two positioning methods that provide sufficient or optimum values for different regions of distances between the two inductive charging devices. It may also be advantageous to use different positioning transmitters for the two positioning methods.

The terms “near positioning” and “remote positioning” refer to two different distance ranges between the two inductive charging devices or their two centers. The distance ranges can overlap. The terms “near positioning” and “remote positioning” do not explicitly refer to a near or remote field property of electromagnetic waves.

A near positioning transmitter is a positioning transmitter that can emit positioning signals that are sufficient or optimal for positioning at relatively close distances between the two inductive charging devices. A near positioning transmitter is suitable for emitting a near positioning signal during a positioning process. In particular, a near positioning transmitter can emit near positioning signals that are suitable for positioning up to a sufficiently accurate positioning.

A near positioning can cover a region up to a maximum distance of the near positioning. The maximum distance refers to the distance between the two inductive charging devices. The maximum distance refers to the distance for optimum positioning. In the case of a stationary inductive charging device arranged on or in the substrate, the optimum positioning is that the two centers of the inductive charging devices are one above the other. The maximum distance therefore refers to the distance between the two centers in the plane of travel of the two inductive charging devices.

The maximum distance of the near positioning can be less than two meters. Preferably, the maximum distance can be one meter. The near positioning thus preferably covers a region of a few centimeters to one meter distance between the centers of the two inductive charging devices.

A remote positioning transmitter is a positioning transmitter that can emit one or more positioning signals that are sufficient or optimal for positioning at relatively large distances between the two inductive charging devices. A remote positioning transmitter is suitable for transmitting a remote positioning signal during a positioning process. In particular, a remote positioning transmitter can emit remote positioning signals that are sufficiently accurate for positioning up to a maximum range. The maximum range here is the maximum distance between the two inductive charging devices that can be achieved by combining a local and a remote positioning method.

Remote positioning can cover a region between a minimum and a maximum distance for remote positioning. The maximum distance for remote positioning should be at least as great as the distance from which a driver can no longer see the stationary inductive charging device through the windshield when driving towards it. The maximum distance for remote positioning can be several meters. Preferably, the maximum distance for remote positioning can be between 5 and 15 m, particularly preferably 10 m. The remote positioning can have a minimum distance below which positioning with this method is no longer possible. Advantageously, the minimum distance for remote positioning is at least as great as the maximum distance for near positioning. However, it is also possible that the minimum distance for remote positioning is smaller than the maximum distance for near positioning. In this case, there is a short transition range in which positioning is required without a positioning method. For example, positioning can simply continue in the corresponding direction after the last evaluated signal of the remote positioning until the near positioning provides evaluable signals. Alternatively, it is also possible for the minimum distance for remote positioning to be greater than the maximum distance for near positioning. In this case, the two positioning methods overlap.

The minimum distance for remote positioning can be between 20 cm and 1 m. Preferably, the minimum distance for remote positioning can be approx. 0.5 m.

The term “far” therefore preferably refers to a distance range between 0.5 m and 10 m. The term “close” therefore preferably refers to a distance range of less than 1 m.

It is understood that the above-mentioned features and those yet to be explained below can be used not only in the combination indicated in each case, but also in other combinations or on their own, without deviating from the scope of the present invention.

Preferably, the inductive charging device is a mobile inductive charging device which is arranged on and/or in a vehicle, or the inductive charging device is a stationary inductive charging device.

A stationary inductive charging device is the non-mobile part of a vehicle charging system, i.e., the part that does not move with the vehicle.

A stationary inductive charging device can preferably be located on, attached to, or in a floor. This may be an inductive charging device placed on the substrate or an inductive charging device sunk into a substrate or into the ground. A floor can be a road, a parking lot surface, a garage floor, a floor in a parking garage or another building. Alternatively, a stationary inductive charging device can also be located on walls or the like.

It is also possible that it is a stationary inductive charging device for a dynamic inductive charging process. In a dynamic inductive charging process, a vehicle's energy storage system can be charged while the vehicle is moving. In this case, for example, the stationary inductive charging device can extend along the road under, in, or on the road surface.

A mobile inductive charging device can be arranged on and/or in a vehicle. In general, this is understood to mean the part of a vehicle charging system that moves along with the vehicle.

Advantageously, the near positioning transmitter has several near transmission windings, preferably at least four near transmission windings, which are arranged spaced apart from one another and which are each suitable for generating a near positioning signal.

A near transmission winding is one or part of a transmit coil that can generate a near positioning signal. The near positioning signal can be an alternating magnetic field and have a specific frequency or a specific frequency band. The frequencies of the near positioning signals can be in the region of 5 kHz to 150 kHz, preferably in the region of 110 kHz to 148.5 kHz, particularly preferably in the region of 120 kHz and 145 kHz. The frequencies used can be, for example, several of the following frequencies: 111.483 kHz and 111.982 kHz and 112.994 kHz and 113.507 kHz and 116.009 kHz. A transmit coil can be significantly smaller than an energy transmission winding and can also be smaller than a sensor winding. A near transmission winding can, for example, be designed in the form of a flat coil. The near transmission winding can be arranged at a distance from the energy transmission winding and at a distance from the flux guiding element(s). Alternatively, a near transmission winding can also be arranged in the region of the energy transmission winding and/or in the region of the flux guiding element(s). In principle, a near transmission winding can be arranged at any level of an inductive charging device. In the case of inductive charging devices arranged parallel to the driving plane, this corresponds to an arrangement at different heights. A near transmission winding can be arranged between the at least one flux guiding element and the energy transmission winding. Alternatively, a near transmission winding can lie in the same plane as the energy transmission winding. In a further alternative embodiment, a near transmission winding may be closer to the further inductive charging device, which forms the counterpart during an inductive charging process, than the energy transmission winding and than the flux guiding elements. In other words, a near transmission winding can be arranged on the side of the energy transmission winding facing away from the flux guiding elements. It is also possible that the near transmission windings are arranged at a distance from the inductive charging device and are only functionally assigned to it. By using several near transmission windings, a simpler positioning method is possible.

If the received signals can be assigned to the individual positioning signals of the near transmission windings, the relative or absolute distance to the respective near transmission windings can be determined from this and used for positioning. For example, the relative distances to two neighboring near transmission windings can be compared with each other.

The use of at least four near transmission windings is advantageous. For example, they can be arranged in the form of a rectangle around a target area. By simply comparing the intensities of the respective different positioning signals, it is possible to position both in the longitudinal direction of the vehicle and perpendicular to the longitudinal direction of the vehicle. A further advantage is that this provides redundancy, as two ratios are formed in each spatial direction. This is particularly relevant for the proposed system, as parasitic effects can occur at very short distances between the near transmission winding and the sensor winding, so that the spatially distributed signals no longer show their maximum directly at the position of the near transmission winding, but that a pronounced “dip” is present there. The term “dip” is used here to describe a local minimum between two local maxima. The position-dependent signal therefore has a characteristic curve with a “double hump.” Such a curve leads to a falsification of the detected position. As the effect of the pronounced “dip” in the spatial distribution only occurs at very short distances, the redundancy proposed here is advantageous, as the signals from the near transmission windings can always be evaluated at a greater distance.

A near transmission winding, as part of an electric coil, can generate an alternating magnetic field by applying an alternating electric current. This alternating magnetic field can, for example, induce an electrical voltage in another remote winding. This means that the same basic physical principle used for energy transmission, namely induction, can also be used to transmit positioning signals. This offers several advantages. First and foremost, certain components, such as electronic components and flux guiding elements, can be used for both energy transmission and positioning signal transmission. An alternating electric current with an effective value of between 500 mA and 1 A can flow through the near transmission winding. Preferably, the effective value of the alternating current is 700 mA.

Particularly advantageous are the near transmission windings with a winding axis perpendicular to the substrate.

A near transmission winding can be made of copper. A near transmission winding can have between 10 and 50 windings. Preferably, a near transmission winding has between 20 and 40 windings. Particularly preferably, a near transmission winding has 28 windings. A near transmission winding can have a diameter of between 50 and 100 mm. For example, a near transmission winding has a diameter of 72 mm.

For example, a near transmission winding can be designed as a flat coil. A flat coil can be a spiral flat coil, in particular a circular spiral flat coil or a rectangular spiral flat coil. A spiral flat coil can be wound in the form of an Archimedean spiral. The shape of the winding can be circular (circular spiral flat coil), but other shapes are also possible, such as square-like or rectangle-like or even similar to a rectangle with rounded corners (rectangular spiral flat coil). The spiral can lie in one plane. A flat coil is particularly suitable for use in a vehicle, as the installation space along the height of a vehicle is limited. A flat coil is advantageous because it has the smallest possible expansion in this direction. An expansion in the two dimensions parallel to the substrate and perpendicular to the height of a vehicle is advantageous, as this maximizes the tolerance range for positioning in which the coupling between the energy transmission windings is still sufficient for energy transmission.

Alternatively, a near transmission winding can be designed as a cylindrical coil. A cylindrical coil can be quite flat in this case. A corresponding cylindrical coil can be wound around a winding body and have a height along the winding axis of between 5 mm and 15 mm.

The near positioning signals can be alternating magnetic fields with different frequencies or with the same frequency but different pulse widths.

In a near positioning method, different transmitted and received near positioning signals can be compared and thus a deviation from an optimal position can be determined. To do this, several near positioning signals must be generated that can be distinguished from one another. These near positioning signals must differ from each other in a differentiation criterion. One possible differentiation criterion is the frequency. The intervals between two frequencies can be between 0.1 and 1 kHz. The frequencies used can be, for example, four or more of the following frequencies: 111.483 kHz and 111.982 kHz and 112.994 kHz and 113.507 kHz and 116.009 kHz.

Another option is to select only one frequency for all near positioning signals, but to use different pulse widths for the various near positioning signals as a distinguishing criterion.

Preferably, the remote positioning transmitter device has a positioning signal winding, wherein the positioning signal winding is designed as a solenoid with a winding axis in the longitudinal direction of the vehicle or nominal longitudinal direction of the vehicle, and the flux guiding element is suitable for guiding a magnetic field during an energy transmission process which takes place between a further inductive charging device and the energy transmission winding, which takes place between a further inductive charging device and the energy transmission winding, and the positioning signal winding encloses at least one of the at least one flux guiding elements and the positioning signal winding is suitable for generating the remote positioning signal and the remote positioning signal is an alternating magnetic field.

A remote positioning signal winding can emit a positioning signal during a positioning process.

A remote positioning signal winding can have several windings, preferably between 10 and 15 windings, particularly preferably 13 windings. For example, a remote positioning signal winding can generate an alternating magnetic field with a certain frequency due to an alternating current. The effective current of the alternating current in the remote positioning signal winding can be between 100 and 500 mA. The effective current of the alternating current is preferably 260 mA.

In principle, an energy transmission winding can also emit a positioning signal, but it is advantageous, as proposed here, to use a separate remote positioning signal winding to generate a positioning signal. In particular, the remote positioning signal winding can generate magnetic fields which are more suitable for positioning and, in particular, enable a greater range with the same power. The energy transmission windings are designed to couple as well as possible with the corresponding counterpart. They therefore generally do not have a long range with regard to the transmission or reception of magnetic fields in the longitudinal direction of the vehicle or the nominal longitudinal direction of the vehicle. However, this is crucial for a positioning process.

During positioning, the maximum possible power or the maximum possible magnetic fields of the positioning signal are severely limited. They are significantly lower than is the case with an energy transmission process. During the positioning process, there is no vehicle on the stationary inductive charging device. It is therefore possible, for example, for a person to be standing on the stationary inductive charging device. To ensure that the magnetic fields remain safe for a person, they must not exceed flux densities of 27 μT or 6.25 μT, depending on the frequency range.

With a proposed remote positioning signal winding, it is possible to generate positioning signals that comply with the limit values or reference values and still enable a long range.

A solenoid is also known as a cylindrical coil or solenoid coil. A solenoid can be wound in the form of a helix or a cylindrical spiral. However, the winding shape does not have to be circular, but can also have other shapes, such as square or rectangular or even similar to a rectangle with rounded corners. The important difference to the flat coil is that the windings are not in one plane, but extend along an axis. However, two or more windings can also run parallel and thus be located in the same plane perpendicular to the axis.

A stationary inductive charging device has a nominal longitudinal direction of the vehicle. This is the direction in which the longitudinal direction of the vehicle should be after a successful positioning process.

If the remote positioning signal winding is located in a mobile inductive charging device of a vehicle, the winding axis of the remote positioning signal winding is aligned in the longitudinal direction of the vehicle. If the remote positioning signal winding is located in a stationary inductive charging device, the winding axis of the remote positioning signal winding is aligned in the nominal longitudinal direction of the vehicle.

The remote positioning signal winding can have an extension along the winding axis of between 10 mm and 60 mm. Preferably, the remote positioning signal winding has an extension along the winding axis of 40 mm.

In the proposed arrangement, the flux guiding element takes over the guidance of a magnetic field for energy transmission during an energy transmission process and the guidance of a magnetic field for positioning during a positioning process. Thus, the flux guiding element performs a dual function, which is particularly advantageous, as material and installation space can be used efficiently.

It is particularly preferable for the remote positioning signal winding to be arranged around the entire width of the inductive charging device in order to cover as large an area as possible and thus generate a magnetic field that is as homogeneous as possible.

In one variant, the remote positioning signal winding is arranged around at least one of the at least one flux guiding element and around the energy transmission winding. This is advantageous because the remote positioning signal winding can be arranged around an otherwise pre-assembled inductive charging device. In addition, a larger area is covered by the remote positioning signal winding if it is arranged around at least one of the at least one flux guiding element and around the energy transmission winding than, for example, if it is arranged around only one or more flux guiding elements. In this way, the local maximum values of the flux density are further reduced for the same power, or in other words, a higher power can be used while maintaining the flux density reference values or flux density limit values, and thus a greater range can be achieved.

It is advantageous if the same basic physical principle is used for a remote positioning method as for energy transmission, as certain components such as flux guiding elements or electronic components can be used together. It can be particularly advantageous if both the near positioning signal(s) and the remote positioning signal(s) are alternating magnetic fields. Here again, further components can be used together. For example, both signal types—remote positioning signal and near positioning signal—can be received with the same sensor.

An alternating magnetic field can be generated, for example, by means of a coil or a current-carrying winding of a coil. The alternating magnetic field can have a frequency between 100 and 150 kHz. Preferably, the frequency can be between 110 and 148.5 kHz. For example, the frequency used may be one of the following frequencies: 145.560 kHz and 145.985 kHz and 146.843 kHz and 147.275 kHz.

The invention also relates to a vehicle charging system having a mobile inductive charging device and a stationary inductive charging device, wherein the mobile inductive charging device is designed according to the invention and the stationary inductive charging device has a positioning receiver or the stationary inductive charging device is designed according to the invention and the mobile inductive charging device has a positioning receiver.

It is advantageous if the transmission and reception of the positioning signals, both the remote positioning signals and the near positioning signals, takes place in the respective inductive charging device, as this is where the most accurate information about a precise position or position deviation can be obtained. One of the two inductive charging devices can be designed according to the invention and have a remote and a near positioning transmitter. The other inductive charging device can have a positioning receiver. A positioning receiver is suitable for receiving a near and/or a remote positioning signal.

Advantageously, the inductive charging device with the positioning receiver has at least one flux guiding element and the positioning receiver has at least one first sensor winding and at least one second sensor winding.

The positioning receiver is used to receive the near and/or remote positioning signals and thus forms the central element of the positioning receiver.

A sensor winding according to the invention can be designed in different forms and have half a winding, one winding, or preferably several windings. Of course, a non-complete number of windings, such as 2.5 windings, is also possible. A conductor of such a sensor winding can have a cross-sectional area of between 0.01 and 2 mm², for example. A conductor can be designed here as a stranded wire, as a single conductor, or in another form, for example in the form of a circuit board. In a conductor structure realized on a circuit board, the conductor paths can have cross-sections of the order of 0.8 mm to 35 μm, for example.

Preferably, the at least one flux guiding element is suitable for guiding a magnetic field during an energy transmission process, which takes place between the mobile inductive charging device and the stationary inductive charging device, and the first sensor winding and the second sensor winding are arranged around at least one of the at least one flux guiding element.

Due to the arrangement of the first sensor winding and the second sensor winding around at least one of the at least one flux guiding element, the at least one of the at least one flux guiding element assumes a dual function here. It acts both as a magnetic core for the first sensor winding and/or the second sensor winding and as a magnetic core or flux guiding element for the energy transmission winding. This means that no separate flux guiding element is required for the sensor winding, which simplifies production.

The arrangement of a sensor winding around a flux guiding element here means that at least part of the flux guiding element is enclosed by a sensor winding. The first sensor winding and the second sensor winding can be arranged around the same flux guiding element or around two different flux guiding elements, or each can be arranged around several flux guiding elements.

The two sensor windings can either be arranged only around one or more flux guiding elements or also around other elements, such as the energy transmission winding and/or around a cooling device and/or around a shielding device.

Advantageously, the first sensor winding has a first radial longitudinal direction and the second sensor winding has a second radial longitudinal direction and the first radial longitudinal direction and the second radial longitudinal direction are arranged at least almost perpendicular to one another and the first radial longitudinal direction and the second radial longitudinal direction are arranged at least almost axially symmetrically to the longitudinal direction of the vehicle or to the nominal longitudinal direction of the vehicle.

In general, a winding extends in at least two dimensions around an axis. The main direction of extension perpendicular to the winding axis is referred to here as the radial longitudinal direction. The main direction of extension therefore runs along or parallel to the longer side of the rectangle in the case of a winding with a rectangular, non-square cross-section. In the case of a winding with an elliptical cross-section, the radial longitudinal direction runs along or parallel to the main axis of the ellipse. The radial longitudinal direction of a sensor winding according to the invention can preferably lie in a plane that extends parallel to the substrate.

A corresponding arrangement of the angles of the radial longitudinal directions is advantageous for the highest possible sensitivity during detection and the simplest possible calculation of the positional deviation between the vehicle and the stationary inductive charging device.

The first sensor winding and the second sensor winding can have an extension of between 10 mm and 60 mm along the winding axis. Preferably, the first sensor winding and the second sensor winding have an extension of 40 mm along the winding axis.

The first sensor winding and the second sensor winding can preferably each have between 10 and 20 windings. It is particularly preferred that the first sensor winding and the second sensor winding each have 15 windings.

If the two angles between the respective radial longitudinal direction of the sensor windings and the longitudinal direction of the vehicle or nominal longitudinal direction of the vehicle are almost the same, this means that the sensor windings are arranged symmetrically to the direction of travel.

This is particularly advantageous as the function of the sensor windings is also to detect a right-left position deviation between the inductive charging device in the vehicle and the stationary inductive charging device. Due to the symmetrical arrangement of the sensor windings in relation to the direction of travel, the corresponding voltages induced in the sensor windings are also symmetrical if the positional deviations to the right or left are the same, making it relatively easy to calculate the positional deviations from the induced voltages.

If the two angles are 45°, the two sensor windings are at a 90° angle to each other, which is ideal for optimum evaluation of the sensor signals.

Preferably, the first sensor winding has a first radial longitudinal direction and the second sensor winding has a second radial longitudinal direction and the first radial longitudinal direction and the second radial longitudinal direction are each arranged at an angle of 45°+/−10°, preferably at an angle of 45°, to the longitudinal direction of the vehicle and the first radial longitudinal direction and the second radial longitudinal direction intersect at an angle of 70°-110°, preferably perpendicularly.

Preferably, the first sensor winding has a first radial longitudinal direction and the second sensor winding has a second radial longitudinal direction and the first radial longitudinal direction and the second radial longitudinal direction intersect in the region of the surface spanned by the energy transmission winding.

The invention further includes a method for positioning a vehicle having a mobile inductive charging device in a defined position relative to a stationary inductive charging device, wherein a remote positioning method is applied while a first start criterion is met and a first end criterion is not met and a near positioning method is applied while a second start criterion is met and a second end criterion is not met.

For efficient energy transmission, the mobile inductive charging device must be positioned as precisely as possible in relation to the stationary inductive charging device. The mobile inductive charging device must therefore be positioned in a defined position relative to a stationary inductive charging device. The defined position is a predetermined position in which it is preferably taken into account that energy can be transferred with the highest possible efficiency. In particular, it can be taken into account that one energy transmission winding in each of the two inductive charging devices is positioned as closely as possible to each other and opposite each other with respect to an air gap between them. As both energy transmission windings generally do not have to be the same size, symmetrical positioning, in which the winding axes of the two energy transmission windings are as close as possible to each other, is also advantageous. Precise positioning is often difficult or impossible for the driver without additional support in the form of a driver assistance system.

Different positioning methods can be advantageous for different distance ranges. Different positioning methods can be used in one positioning process. A remote positioning method can be used for longer distances and a near positioning method for shorter distances.

A remote positioning method can cover distances between 10 m and 0.5 m, for example.

A remote positioning method may be particularly suitable for the distance between the edge of the parking space and 0.5 m in front of the target position.

A near positioning method may be suitable for distances less than 1 m. In particular, a near positioning method may be suitable for distances between 0.5 m in front of the target position and the target position. A near positioning method may end at a sufficient positioning.

A remote positioning method and a near positioning method can be implemented in a similar or significantly different way in terms of the components used and the evaluation. Remote positioning methods and near positioning methods cannot be identical. For both positioning methods, there is a start criterion from which detected signals are suitable and/or advantageous for this positioning method. For both positioning methods, there is an end criterion from which detected signals are no longer suitable and/or no longer advantageous for this positioning method. An end criterion can be fulfilled if the detected signals no longer enable reliable positioning. An end criterion can be fulfilled if another positioning method is more reliable. An end criterion can be fulfilled if a sufficiently accurate position is achieved.

Preferably, the first start criterion involves exceeding a first signal threshold value of a remote positioning signal and the first end criterion involves exceeding a second signal threshold value of a remote positioning signal.

A remote positioning signal can be emitted by an inductive charging device and detected with a certain intensity in another inductive charging device. The intensity of the detected remote positioning signal can increase, in particular increase monotonically, with decreasing distance between the two inductive charging devices. A first signal threshold value can be defined, above which the remote positioning signal is sufficient to serve for a remote positioning method. Below this first signal threshold value, the received remote positioning signal is too weak to be reliably evaluated in a remote positioning method. Thus, a first signal threshold value can be defined as a first start criterion from which a remote positioning method can start.

The remote positioning signal can, for example, induce a voltage in a sensor winding and a signal threshold value can refer to the exceeding of a certain induced voltage.

It is possible that a remote positioning method will no longer function reliably once the distance to the target position falls below a minimum. For example, alternating magnetic fields can be used in the remote positioning method and, in particular, the local direction of the alternating magnetic fields can be used to determine a directional deviation.

Alternating magnetic fields can have very strong local curvatures at short distances to the source—for example to a current-carrying coil—and it is therefore no longer possible to reliably deduce a directional deviation between the two inductive charging devices from the direction of the magnetic fields. Thus, the remote positioning signal may be unusable for a remote positioning method, even if the intensity of the remote positioning signal is sufficient. A second signal threshold value can also be defined for this. If this second signal threshold value is exceeded, the remote positioning signal is no longer suitable for the remote positioning method. Exceeding this second signal threshold value can thus be used as the first end criterion for the remote positioning method.

Particularly preferably, the second start criterion involves exceeding a third signal threshold value of one or more near positioning signals and the second end criterion involves evaluating at least one signal value ratio of two near positioning signals.

A near positioning signal can be emitted by an inductive charging device and detected with a certain intensity in another inductive charging device. The intensity of the detected near positioning signal can increase, in particular increase monotonically, with decreasing distance between the two inductive charging devices. A third signal threshold value can be defined, above which the near positioning signal is sufficient to serve for a near positioning method. Below this third signal threshold value, the received near positioning signal is too weak to be reliably evaluated in a near positioning method. Thus, a third signal threshold value can be defined as a second start criterion from which a near positioning method can start.

The near positioning method can be used until sufficient positioning is achieved. The second end criterion can therefore be fulfilled if the vehicle is positioned sufficiently precisely in relation to the stationary inductive charging device.

In the near positioning method, one or more ratios can be formed from two near positioning signals for this purpose. The near positioning signals can be positioned symmetrically around the optimum position for a sensor device. Sufficient positioning can be achieved if one or more of the ratios of two near positioning signals is equal to 1 or within a narrow tolerance range around the value 1.

Advantageously, the first end criterion is fulfilled at a first switching distance between the mobile inductive charging device and the stationary inductive charging device and the second start criterion is fulfilled at a second switching distance between the mobile inductive charging device and the stationary inductive charging device.

The first end criterion and the second start criterion are selected so that they are each fulfilled at a certain distance between the mobile inductive charging device and the stationary inductive charging device.

From the distance at which the first end criterion is met, the remote positioning method no longer provides sufficiently reliable signals. From the distance at which the second start criterion is met, the near positioning method provides sufficiently reliable signals. It is possible that the distance at which the first end criterion is met is greater than the distance at which the second start criterion is met. In this case, a “blind flight” occurs, i.e., a short transition range in which neither the distance nor the near positioning method can be evaluated. This case is not ideal. However, it can be bridged, for example, by positioning in this transition range in the direction of the direction last specified by the remote positioning method.

It is possible that the distance at which the first end criterion is met and the distance at which the second start criterion is met are at least almost the same. In this case, the near positioning method can take over as soon as the remote positioning method no longer provides sufficient values.

It is possible that the distance at which the first end criterion is fulfilled is smaller than the distance at which the second start criterion is fulfilled. In this case, reliable signals from both the near positioning method and the remote positioning method are obtained in a transition range. In this transition range, either the remote positioning method or the near positioning method can then be used, or both near and remote positioning signals can be evaluated.

Between the first switching distance and the second switching distance there may be a distance of less than 40 cm, preferably less than 20 cm, and particularly preferably less than 10 cm, or the first switching distance may be equal to the second switching distance.

As described above, the first switching distance or the second switching distance can be greater. If the first switching distance is greater, a transition range occurs as described above in which no positioning method can be evaluated. If the second switching distance is greater, there is a transition range in which both positioning methods can be reliably evaluated.

Preferably, the same positioning receiver is used for the remote positioning method and for the near positioning method.

Both the remote positioning signal and the near positioning signals can be alternating magnetic fields, which can be generated by different coils, for example. The near positioning method and the remote positioning method can be significantly different. For example, in the remote positioning method, the direction of the alternating magnetic fields can be evaluated at a certain frequency or in a certain frequency range. This can be used to determine a directional deviation, for example. In the near positioning method, for example, the signal strengths at different frequencies or in different frequency ranges can be set in relation to each other. This can be used to determine a position deviation, for example. It is advantageous if both positioning methods can be evaluated with the same positioning receiver. This can save additional components and therefore installation space.

Advantageously, the mobile inductive charging device and the stationary inductive charging device are part of a vehicle charging system according to the invention and the positioning receiver is a positioning receiver according to the invention.

It is advantageous if the positioning receiver receives and evaluates the at least one remote positioning signal during the remote positioning method and receives and evaluates the at least one near positioning signal during the near positioning method.

It is also quite possible that the positioning receiver also partially or always receives the other positioning signal, but—for example as a function of the start and end criteria—only evaluates the near positioning signal or only evaluates the remote positioning signal. The evaluation does not have to take place in a unit with the sensor technology of the positioning receiver, but can also be evaluated in a spatially separate computing unit.

In an advantageous embodiment, during the remote positioning method, the at least one remote positioning signal induces a voltage in the at least one first sensor winding and a voltage in the at least one second sensor winding, and during the near positioning method, a plurality of near positioning signals induce a plurality of voltages in the at least one first sensor winding and in the at least one second sensor winding.

Preferably, during the remote positioning method, the intensities of the voltage induced in the first sensor winding and the voltage induced in the second sensor winding are compared and a directional deviation value between the longitudinal direction of the vehicle and the nominal longitudinal direction of the vehicle is calculated.

Advantageously, during the near positioning method, the intensities of the voltages induced in the positioning receiver at the different frequencies or the different pulse widths are compared and a position deviation value between the current position and the target position is calculated.

Preferably, after the near positioning method, a position holding test is performed, during which it is continuously checked whether the vehicle is still in a position suitable for energy transmission.

The near positioning method is terminated when the vehicle is in a position suitable for energy transmission.

However, it may be necessary to continuously check during the entire energy transmission process whether the vehicle is still in a suitable position for energy transmission. For example, it must be prevented that the vehicle rolls away during the energy transmission process and the energy transmission continues. This can be checked as part of a position holding test. It can be continuously checked whether the second end criterion is still fulfilled.

If the second end criterion is no longer fulfilled at any time during the position holding test, an alarm can be triggered. The position holding test can end regularly when the energy transmission has ended.

It is possible that a sufficiently accurate positioning for an energy transmission, as can be achieved by the method according to the invention, is only one of several criteria which are a prerequisite for an energy transmission.

In addition to sufficiently precise positioning, it is also possible for a communication check to take place to ensure that a mobile inductive charging device is communicating with the stationary inductive charging device above which it is positioned sufficiently precisely.

In principle, such a communication check can take place at any time during the method according to the invention, but before an energy transmission starts.

Preferred embodiments of the invention are shown in the drawings by way of example and will be explained in more detail in the following description, wherein identical reference numerals refer to identical or similar or functionally identical elements.

### BRIEF DESCRIPTION OF THE DRAWINGS

It shows, each schematically

FIG. 1 a highly simplified representation of a vehicle with an inductive charging device,

FIG. 2 a sectional view of an inductive charging device for a vehicle charging system,

FIG. 3 a top view of an inductive charging device according to the invention with a near positioning transmitter and a remote positioning transmitter,

FIG. 4 a top view of an alternative inductive charging device according to the invention with a near positioning transmitter and a remote positioning transmitter,

FIG. 5 a flat coil as a near positioning transmitter for a near positioning transmitter,

FIG. 6 an inductive charging device with a positioning receiver for a vehicle charging system according to the invention,

FIG. 7 an inductive charging device with a positioning receiver for a vehicle charging system according to the invention,

FIG. 8 a vehicle during a positioning process with a vehicle charging system according to the invention,

FIG. 9 a flowchart of a positioning method according to the invention,

FIG. 10 a flowchart of an alternative positioning method according to the invention,

FIG. 11 a flowchart of a possible position holding test using the near positioning method.

### DETAILED DESCRIPTION

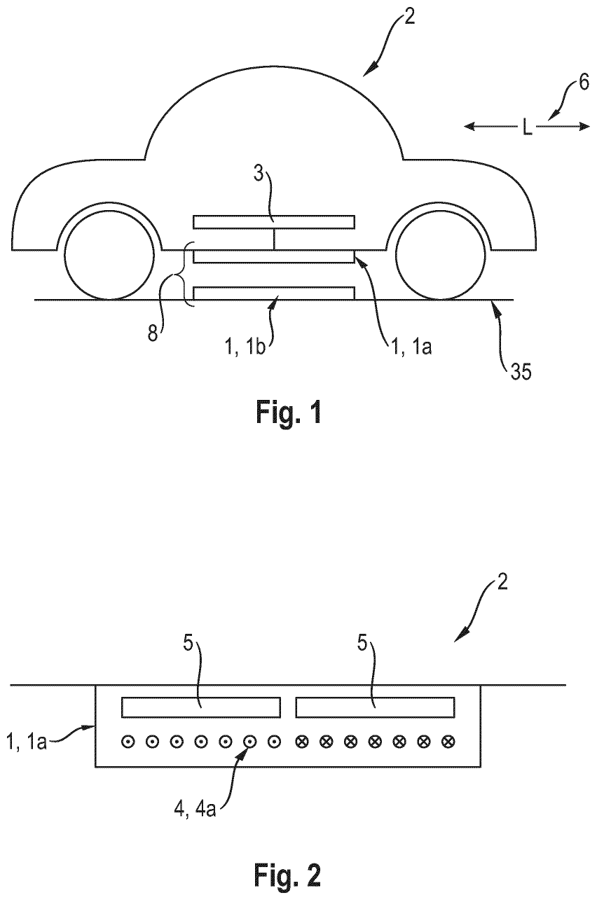

FIG. 1 shows a mobile inductive charging device [symbol] , which is arranged on a vehicle [symbol] with an energy storage device [symbol] and is positioned above a stationary inductive charging device [symbol] . During operation, energy can be transferred from the stationary inductive charging device [symbol] to the mobile inductive charging device [symbol] and the vehicle's energy storage device [symbol] can be charged as a result.

The mobile inductive charging device [symbol] and the stationary inductive charging device [symbol] together form or are part of a vehicle charging system [symbol] . In principle, it is also possible to operate the vehicle charging system [symbol] bidirectionally. Energy can be temporarily transferred from the mobile inductive charging device [symbol] to the stationary inductive charging device [symbol] in the process. The stationary inductive charging device [symbol] shown in FIG. 1 on the substrate [symbol] can alternatively be recessed into the roadway (not shown here). In a recessed arrangement, the inductive charging device [symbol] can be covered by certain layers of the road surface or be flush with the road surface.

FIG. 2 shows a lateral section through an inductive charging device [symbol] , [symbol] which includes several flux guiding elements [symbol] and an energy transmission winding [symbol] , [symbol] and is mounted on a vehicle [symbol] .

A corresponding arrangement exists for a stationary inductive charging device [symbol] , except that it is arranged on a substrate instead of on a vehicle [symbol] (not shown).

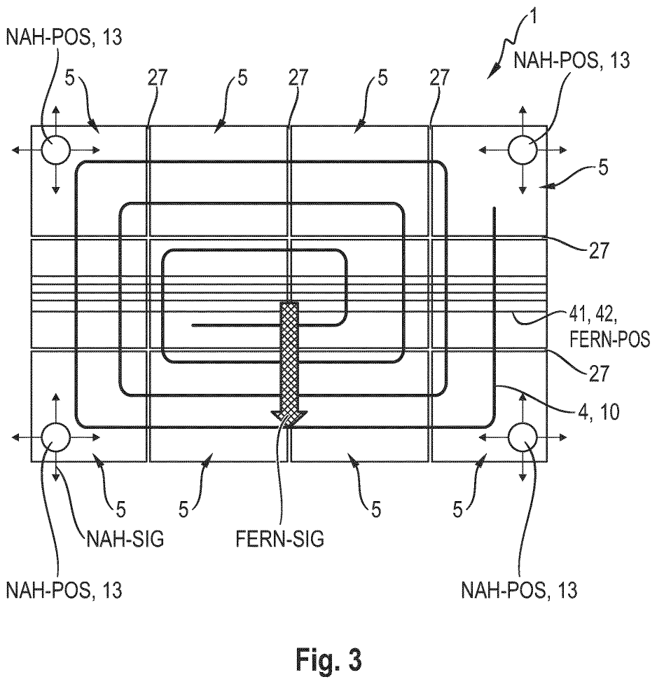

FIG. 3 shows a top view of an inductive charging device according to the invention with a near positioning transmitter NEAR-POS and a remote positioning transmitter REMOTE-POS. The near positioning transmitter NEAR-POS is realized here in the form of four near transmission windings [symbol] . The remote positioning transmitter REMOTE-POS is realized here as a solenoid [symbol] . The remote positioning transmitter REMOTE-POS transmits a remote positioning signal REMOTE-SIG in the form of an alternating magnetic field during a positioning process. During a positioning process, the near positioning transmitter NEAR-POS emits several near positioning signals NEAR-SIG in the form of alternating magnetic fields which differ, for example, in frequency.

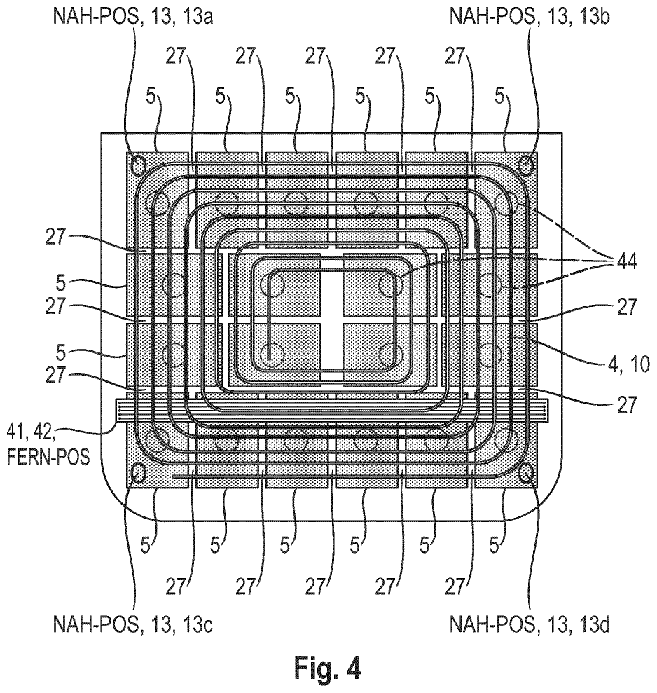

FIG. 4 shows a top view of an alternative inductive charging device according to the invention with a near positioning transmitter NEAR-POS and a remote positioning transmitter REMOTE-POS. Here, too, the near positioning transmitter NEAR-POS is realized as four near transmission windings [symbol] and the remote positioning transmitter REMOTE-POS as a solenoid [symbol] . This embodiment shows an alternative arrangement of the flux guiding elements [symbol] , furthermore the remote positioning signal winding [symbol] does not run centrally through the middle of the inductive charging device [symbol] , but is shifted towards one edge.

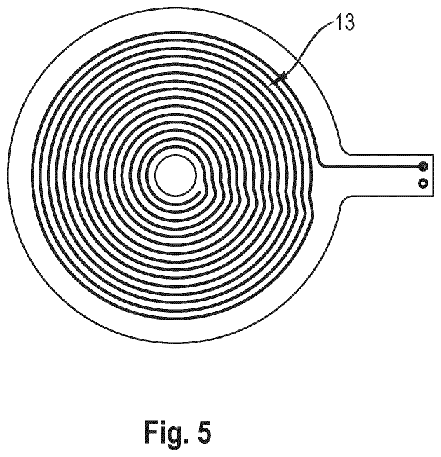

FIG. 5 shows a near transmission winding [symbol] , which is designed as a flat coil [symbol] .

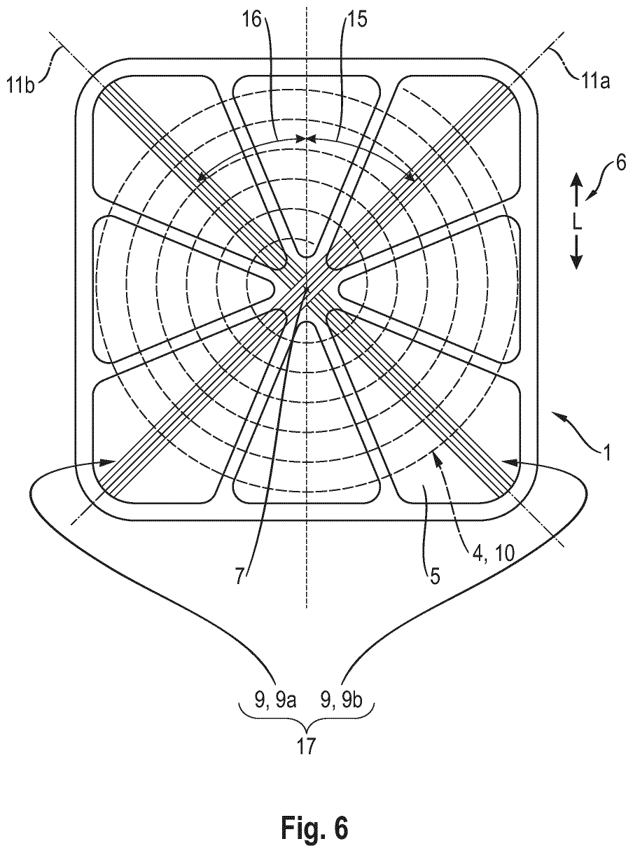

FIG. 6 shows a further inductive charging device [symbol] which has a positioning receiver [symbol] with two sensor windings 9a and 9b, which are part of a sensor device. This can be a mobile inductive charging device [symbol] or a stationary inductive charging device [symbol] . In the present embodiment example, eight flux guiding elements [symbol] are shown, which are arranged radially around the center [symbol] of the energy transmission winding [symbol] in the plane. There are narrow gaps [symbol] between the flux guiding elements [symbol] . The gaps also run radially around the center [symbol] , so the gaps run almost in the main direction of the magnetic field lines (three magnetic field lines [symbol] symbolically indicated here), which occurs when energy is transferred in the flux guiding elements [symbol] . The energy transmission winding [symbol] , which is covered by the flux guiding elements [symbol] in the top view, is indicated by a dashed line. The energy transmission winding [symbol] here is a flat coil [symbol] .

The sensor windings are designed here as a solenoid, also known as a cylindrical coil.

The first sensor winding [symbol] runs around two flux guiding elements [symbol] which are diagonally opposite each other with respect to the center [symbol] of the energy transmission coil [symbol] . The second sensor winding [symbol] is accordingly wound around two further flux guiding elements [symbol] , which are also diagonally opposite each other with respect to the center [symbol] . The first sensor winding [symbol] is arranged axially symmetrically to the second sensor winding [symbol] with respect to the longitudinal direction of the vehicle [symbol] . The first sensor winding [symbol] and the second sensor winding [symbol] cross at least almost in the center [symbol] of the energy transmission coil [symbol] .

The first sensor winding [symbol] has a first radial longitudinal direction [symbol] and the second sensor winding [symbol] has a second radial longitudinal direction [symbol] . The angle [symbol] between the first radial longitudinal direction [symbol] and the longitudinal direction of the vehicle [symbol] is at least almost the same as the angle [symbol] between the second radial longitudinal direction [symbol] and the longitudinal direction of the vehicle [symbol] .

During the charging process, the vehicle [symbol] is positioned above the stationary inductive charging device [symbol] and energy is transferred to the inductive charging device [symbol] . The flux guiding elements [symbol] assume the function of the flux guide. In them, the field lines of the magnetic field run approximately in a radial direction when charged. As the first radial longitudinal direction [symbol] and the second radial longitudinal direction [symbol] are also aligned radially and therefore at least almost parallel to the magnetic field lines, relatively little to no voltage is induced in the first sensor winding [symbol] and in the second sensor winding [symbol] in this case. This is important, as the high power of the energy transmission and therefore high flux densities could otherwise easily destroy the sensor windings. Additional effort to prevent the destruction of the arrangement is therefore not necessary.

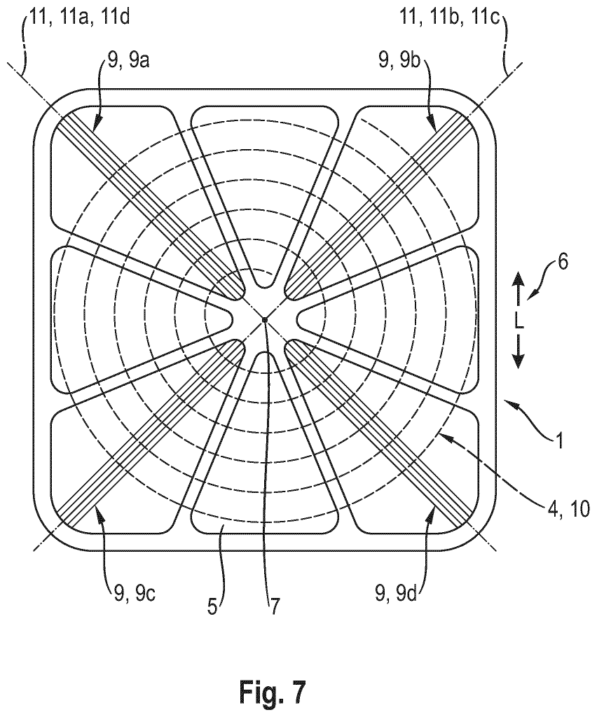

FIG. 7 shows a top view of a further embodiment of an inductive charging device [symbol] according to the invention. Here there are four sensor windings [symbol] , with four radial longitudinal directions [symbol] . Each sensor winding is arranged around a different flux guiding element [symbol] . Two of the flux guiding elements are diagonally opposite each other in relation to the center [symbol] of the energy transmission coil [symbol] . Together, the four sensor windings [symbol] , again form a cross-shaped arrangement. An advantage over the arrangement in FIG. 6 is that the area around the center [symbol] of the energy transmission coil [symbol] is designed without a sensor winding [symbol] in this case. This means that mechanically necessary support elements (not shown) can still be arranged here.

The inductive charging device according to the invention from FIG. 3 and FIG. 4 and the further inductive charging device from FIG. 6 and FIG. 7 can be part of a vehicle charging system according to the invention [symbol] . Here, the one positioning receiver [symbol] can receive signals from the near positioning transmitter NEAR-POS as well as signals from the remote positioning transmitter REMOTE-POS. This is advantageous because one positioning receiver [symbol] can be used to operate two different positioning methods that function optimally at two different distance ranges.

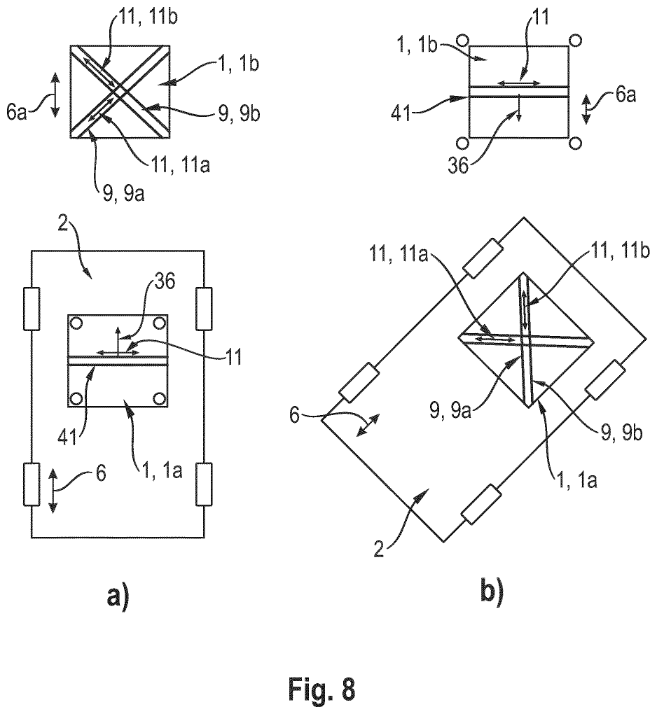

FIG. 8 a) shows a vehicle [symbol] with a longitudinal direction of the vehicle [symbol] and having a mobile inductive charging device [symbol] during a positioning process over a stationary inductive charging device [symbol] with a nominal longitudinal direction of the vehicle [symbol] . The vehicle [symbol] drives directly towards the stationary inductive charging device [symbol] and the nominal longitudinal direction of the vehicle [symbol] is therefore the same as the longitudinal direction of the vehicle [symbol] . In the mobile inductive charging device [symbol] , in addition to the energy transmission winding (not shown), there is also a remote positioning signal winding [symbol] and four near transmission windings [symbol] . The remote positioning signal winding [symbol] has a winding axis [symbol] and a radial longitudinal direction [symbol] . The four near transmission windings [symbol] have winding axes perpendicular to the substrate. In addition to the energy transmission winding (not shown), the stationary inductive charging device [symbol] has two sensor windings [symbol] and [symbol] . Both sensor windings [symbol] and [symbol] each have a radial longitudinal direction [symbol] and [symbol] . Both sensor windings [symbol] and [symbol] are arranged symmetrically to the nominal longitudinal direction of the vehicle [symbol] . This arrangement of the windings for positioning is particularly advantageous. The remote positioning signal winding [symbol] generates a fairly homogeneous magnetic field. A voltage is induced in the sensor windings [symbol] and [symbol] by the magnetic field of the remote positioning signal winding [symbol] . If the vehicle drives exactly perpendicular to the stationary inductive charging device [symbol] as shown in the left-hand sketch, an equal voltage is induced in both sensor windings [symbol] and [symbol] during the remote positioning method REMOTE_V. From a certain distance, the near positioning method NEAR_V is used and the near positioning signals NEAR-SIG emitted by the near transmission windings [symbol] are evaluated.

FIG. 8 b) shows an embodiment example in which the remote positioning signal winding [symbol] and the four near transmission windings [symbol] are arranged in the stationary inductive charging device [symbol] and the sensor windings [symbol] and [symbol] are arranged in the mobile inductive charging device [symbol] . The functionality of this exemplary embodiment is otherwise exactly the same. Shown here is a case in which the vehicle [symbol] does not approach the stationary inductive charging device [symbol] perpendicularly, but deviates from it at an angle of approx. 45°. The longitudinal direction of the vehicle [symbol] and the connecting line between the stationary inductive charging device [symbol] and the mobile inductive charging device [symbol] are therefore at a directional deviation angle of 45° from each other. In this case, the remote positioning signal winding [symbol] generates a magnetic field which is perpendicular to the first sensor winding [symbol] . Here, a maximum voltage is induced into the first sensor winding [symbol] during the remote positioning method REMOTE_V. The magnetic field generated by the remote positioning signal winding [symbol] is also almost parallel to the second sensor winding [symbol] . A minimum or no voltage is induced here during the remote positioning method REMOTE_V. Here, too, the near positioning method NEAR_V can take over from a certain distance.

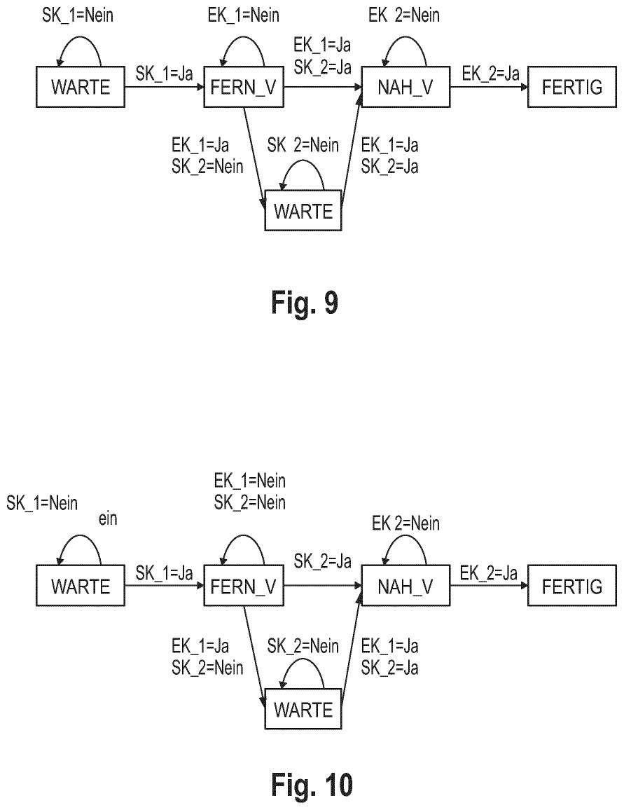

FIG. 9 shows a flowchart of a positioning method according to the invention, which includes a remote positioning method REMOTE_V and a near positioning method NEAR_V. First, a continuous check is carried out to determine whether a first start criterion SK_1 is fulfilled. This can be, for example, the exceeding of a signal threshold value of a voltage induced in one or more sensor windings. As long as this signal threshold value is not reached, the detected signal is not sufficient for the remote positioning method REMOTE_V and the method is in a waiting state WAIT. Positioning is not possible. As soon as the first start criterion SK_1 is fulfilled, the remote positioning method REMOTE_V starts and it is continuously checked whether the first end criterion EK_1 is fulfilled.

The first end criterion EK_1 can be the exceeding of a signal threshold value of a voltage induced in one or more sensor windings. The background to this is that below a minimum distance, the remote positioning method REMOTE_V no longer functions reliably due to excessive curvature of the magnetic field lines.

The remote positioning method REMOTE_V is terminated when the first end criterion EK_1 is fulfilled. There are two possibilities here. The first possibility is that a second start criterion for the near positioning method has not yet been fulfilled at this point.

The second start criterion SK_2 can be the exceeding of a signal threshold value of a voltage induced in one or more sensor windings.

As long as the second start criterion SK_2 is not yet fulfilled, the remote positioning method REMOTE_V can no longer be used here and the near positioning method NEAR_V cannot yet be used. The method is therefore once again in a waiting state WAIT. This results in a brief “blind flight” between the two positioning methods. For example, it may be instructed to continue positioning in the last direction specified by the remote positioning method REMOTE_V until the near positioning method NEAR_V is possible. During this waiting state WAIT, the system continuously checks whether the second start criterion SK_2 is fulfilled.

As soon as the second start criterion SK_2 is fulfilled, the near positioning method NEAR_V can be started.

The second option is that the second start criterion SK_2 is already fulfilled as soon as the end criterion EK_1 is fulfilled. In this case, the near positioning method NEAR_V can be started directly after the remote positioning method REMOTE_V.

During the near positioning method, the system continuously checks whether the second end criterion EK_2 is fulfilled. The second end criterion EK_2 can be fulfilled if the vehicle is positioned with sufficient accuracy. This can include, for example, that two voltages induced in sensor windings are set in relation to each other and this value is equal to 1 or lies within a narrow tolerance range around the value 1.

As soon as the second end criterion EK_2 is fulfilled, the near positioning method NEAR_V ends and the vehicle is sufficiently positioned.

FIG. 10 shows a flowchart of an alternative positioning method according to the invention. In principle, this positioning method runs in the same way as the positioning method described in FIG. 9. The difference here is that during the remote positioning method REMOTE_V it is continuously checked whether the first end criterion EK_1 is fulfilled and whether the second start criterion SK_2 is fulfilled. In this variant, the remote positioning method REMOTE_V is terminated as soon as one of the two criteria is met. If the second start criterion SK_2 is fulfilled, the near positioning method NAV_V is started directly, regardless of whether the first end criterion EK_1 is fulfilled or not. If the first end criterion EK_1 is fulfilled first and the second start criterion SK_2 is not yet fulfilled, a waiting state WAIT is also reached, as in the exemplary embodiment in FIG. 9. As soon as the second start criterion SK_2 is fulfilled, the near positioning method NEAR_V starts.

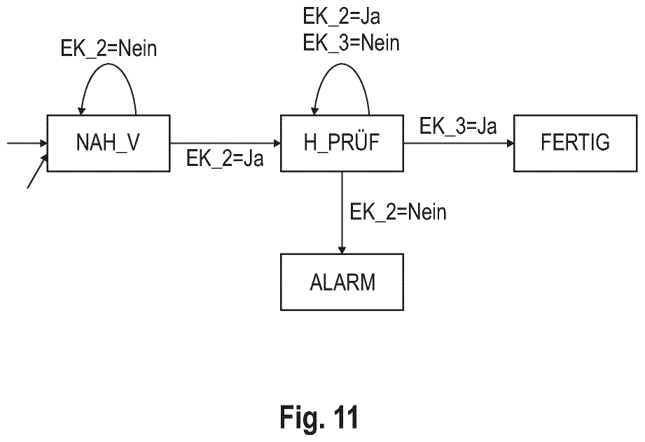

FIG. 11 shows a possible intermediate step between the end of the near positioning method NEAR_V and the end of the complete positioning method DONE. This intermediate step can optionally be used in the variant shown in FIG. 9 or the variant shown in FIG. 10.

The near positioning method NEAR_V ends when the vehicle is sufficiently positioned and thus the second end criterion EK_2 is fulfilled. However, it can also be important to check during the entire charging process whether the second end criterion EK_2 remains fulfilled. For example, the vehicle could roll away during a charging process. In this case, it must be ensured that this is detected and a corresponding ALARM alarm status is triggered so that the charging process can be terminated immediately. This can be done by means of a position holding test H_TEST. This continuously checks whether the second end criterion EK_2 is still fulfilled and a third end criterion EK_3 is not yet fulfilled. If the second end criterion EK_2 is no longer fulfilled during the position holding test H_TEST, the vehicle is no longer in a suitable position for the energy transmission and an ALARM alarm state is triggered so that the energy transmission is terminated. If the energy transmission is regularly terminated, the third end criterion EK_3 is fulfilled. The positioning method is thus terminated.

1. An inductive charging device for a vehicle charging system comprising:
an energy transmission winding and at least one flux guiding element,
a near positioning transmitter suitable for generating at least one near positioning signal, and
a remote positioning transmitter suitable for generating at least one remote positioning signal.

2. The inductive charging device according to claim 1, wherein:
the inductive charging device is a mobile inductive charging device arranged on and/or in a vehicle, or
the inductive charging device is a stationary inductive charging device.

3. The inductive charging device according to claim 1, wherein:
the near positioning transmitter has a plurality of near transmission windings that are arranged spaced apart from one another, and
the plurality of near transmission windings are each suitable to generate a near positioning signal.

4. The inductive charging device according to claim 3, wherein the plurality of near transmission windings are structured and arranged with a winding axis perpendicular to a substrate.

5. The inductive charging device according to claim 3, wherein the near-positioning signals are alternating magnetic fields with different frequencies or with the same frequency and different pulse widths.

6. The inductive charging device according to claim 1, wherein the remote positioning transmitter has a remote positioning signal winding, wherein:
the remote positioning signal winding is a solenoid with a winding axis in a longitudinal direction of the vehicle or nominal longitudinal direction of the vehicle,
the at least one flux guiding element is suitable for guiding a magnetic field during an energy transmission process that takes place between a further inductive charging device and the energy transmission winding,
the remote positioning signal winding encloses the at least one flux guiding element,
the remote positioning signal winding is suitable for generating the remote positioning signal, and
the remote positioning signal is an alternating magnetic field.

7. A vehicle charging system, comprising: a mobile inductive charging device and a stationary inductive charging device, wherein
the mobile inductive charging device is an inductive charging device and the stationary inductive charging device has a positioning receiver, or
the stationary inductive charging device is an inductive charging device and the mobile inductive charging device has a positioning receiver,
the induction charging device including:
an energy transmission winding and at least one flux guiding element,
a near positioning transmitter suitable for generating at least one near positioning signal, and
a remote positioning transmitter suitable for generating at least one remote positioning signal.

8. The vehicle charging system according to claim 7, wherein the stationary or mobile inductive charging device with the positioning receiver has at least one flux guiding element and the positioning receiver comprises at least one first sensor winding and at least one second sensor winding.

9. The vehicle charging system according to claim 8, wherein:
the at least one flux guiding element is suitable for guiding a magnetic field during an energy transmission process that takes place between the mobile inductive charging device and the stationary inductive charging device, and
the at least one first sensor winding and the at least one second sensor winding are arranged around at least one of the at least one flux guiding element.

10. The vehicle charging system according to claim 8, wherein:
the at least one first sensor winding has a first radial longitudinal direction and the at least one second sensor winding has a second radial longitudinal direction, and
the first radial longitudinal direction and the second radial longitudinal direction are arranged at least approximately perpendicular to each other, and/or
the first radial longitudinal direction and the second radial longitudinal direction are arranged at least almost axially symmetrically to a longitudinal direction of the vehicle or to a nominal longitudinal direction of the vehicle.

11. A method for positioning a vehicle having a mobile inductive charging device in a defined position relative to a stationary inductive charging device, the method comprising:
using a remote positioning method while a first start criterion is fulfilled and a first end criterion (EK_1) is not fulfilled,
using a near positioning method while a second start criterion is fulfilled and a second end criterion is not fulfilled.

12. The method according to claim 11, wherein:
the first start criterion includes exceeding a first signal threshold value of a remote positioning signal, and
the first end criterion includes exceeding a second signal threshold value of a remote positioning signal.

13. The method according to claim 11, wherein:
the second start criterion includes exceeding of a third signal threshold value of one or more near positioning signals, and
the second end criterion includes evaluating at least one signal value ratio of two near positioning signals.

14. The method according to claim 11, wherein:
the first end criterion is fulfilled at a first switching distance between the mobile inductive charging device and the stationary inductive charging device, and
the second start criterion is fulfilled at a second switching distance between the mobile inductive charging device and the stationary inductive charging device.

15. The method according to claim 14, wherein:
there is a distance of less than 40 cm, between the first switching distance and the second switching distance, or
the first switching distance is equal to the second switching distance.

16. The method according to claim 11, wherein the same positioning receiver is used for the remote positioning method and for the near positioning method.

17. The method according to claim 16, wherein the mobile inductive charging device and the stationary inductive charging device are part of a vehicle charging system.

18. The method according to claim 16, wherein the positioning receiver:
receives and evaluates the at least one remote positioning signal during the remote positioning method, and
receives and evaluates at least one near positioning signal during the near positioning method.

19. The method according to claim 18, wherein:
during the remote positioning method, the at least one remote positioning signal induces a voltage in at least one first sensor winding and induces a voltage in at least one second sensor winding, and
during the near positioning method, several near positioning signals induce several voltages in the at least one first sensor winding and in the at least one second sensor winding.

20. The method according to claim 19, wherein during the remote positioning method:
the intensities of the voltage induced in the at least one first sensor winding and the voltage induced in the at least one second sensor winding are compared, and
a directional deviation value is calculated between a longitudinal direction of the vehicle and a nominal longitudinal direction of the vehicle.

21. The method according to claim 19, wherein during the near positioning method:
the intensities of the voltages induced in the at least one first sensor windings and the at least one second sensor winding at different frequencies or different pulse widths are compared, and
a position deviation value between a current position and a target position is calculated.

22. The method according to claim 11, wherein after the near positioning method, a position holding test is still carried out, during which it is continuously checked whether the vehicle is still in a position suitable for energy transmission.
